(19) United States
(12) Patent Application Publication
(10) Pub. No.: US 2016/0339396 A1
(43) Pub. Date: Nov. 24, 2016

(54) METHOD FOR PRODUCING COMPOSITE SEMIPERMEABLE MEMBRANE

(71) Applicant: NITTO DENKO CORPORATION, Ibaraki-shi (JP)

(72) Inventors: Shinichi Inoue, Ibaraki-shi (JP); Shinya Nishiyama, Ibaraki-shi (JP); Junko Nakano, Ibaraki-shi (JP)

(21) Appl. No.: 15/114,975

(22) PCT Filed: Jan. 6, 2015
(86) PCT No.: PCT/JP2015/050135

§ 371 Date: Jul. 28, 2016

(30) Foreign Application Priority Data
Feb. 7, 2014 (JP) 2014-022380

(51) Int. Cl. B01D 71/56; B01D 67/00; B01D 69/12

(52) U.S. Cl. CPC B01D 71/56; B01D 69/125; B01D 67/0006; B01D 67/0095; B01D 2323/08; B01D 2323/30; B01D 2323/40

(57) ABSTRACT

The purpose of the present invention is to provide: a composite semipermeable membrane that has excellent oxidation resistance compared to the prior art; and a method for producing the composite semipermeable membrane. The method for producing a composite semipermeable membrane is characterized by: comprising a step in which an amine solution containing a polyfunctional amine component and an organic solution containing a polyfunctional acid halide component are brought into contact on a porous support to form a skin layer containing a polyamide resin on the surface of the porous support, wherein the polyfunctional amine component contains N,N′ -dimethyl-meta-phenylenediamine and the solvent of the organic solution is an organic solvent having a boiling point of 130 to 250° C.

### TECHNICAL FIELD

The present invention relates to a composite semipermeable membrane wherein a skin layer containing a polyamide resin is formed on the surface of a porous support, and a method for producing the same. The composite semipermeable membrane is suitably used for production of ultrapure water, desalination of brackish water or sea water, etc., and usable for removing or collecting pollution sources or effective substances from pollution, which causes environment pollution occurrence, such as dyeing drainage and electrodeposition paint drainage, leading to contribute to closed system for drainage. Furthermore, the membrane can be used for concentration of active ingredients in foodstuffs usage, for an advanced water treatment, such as removal of harmful component in water purification and sewage usage etc. Moreover, the membrane can be used for waste water treatment in oil fields or shale gas fields.

### BACKGROUND ART

Currently, composite semipermeable membranes, in which a skin layer including a polyamide resin obtained by interfacial polymerization of a polyfunctional amine and a polyfunctional acid halide is formed on a porous support, have been proposed (Patent Documents 1 to 4).

In a water treatment process using a composite semipermeable membrane, there is a problem of biofouling that is generated by adhesion of microorganisms in water to the membrane, leading to decrease in water permeability of the membrane. As a method of suppressing such biofouling, there is exemplified, for example, a treatment method for sterilizing microorganisms in water with an oxidizing agent.

However, the composite semipermeable membranes of Patent Documents 1 to 4 could not be used in the case where a treatment method for sterilizing microorganisms in water with an oxidizing agent was adopted, because the membrane did not have an oxidant resistance (chlorine resistance) that could withstand a long-term continuous operation at a chlorine concentration (1 ppm or more as a free chlorine concentration) capable of inhibiting the growth of microorganisms.

Therefore, development of a composite semipermeable membrane having superior oxidant resistance relative to the prior art has been desired.

### PRIOR ART DOCUMENTS

### Patent Documents

Patent Document 1: JP-A-H8-224452

Patent Document 2: JP-A-2005-103517

Patent Document 3: JP-A-2005-205279

Patent Document 4: JP-A-2006-26484

### SUMMARY OF THE INVENTION

### Problems to be Solved by the Invention

The purpose of the present invention is to provide: a composite semipermeable membrane that has excellent oxidation resistance compared to the prior art; and a method for producing the composite semipermeable membrane.

### Means for Solving the Problems

The present inventors have made extensive and intensive investigations to achieve the above object. As a result, it has been found that a composite semipermeable membrane having excellent oxidation resistance can be obtained by the following production method. The present invention has been completed on the basis of these findings.

That is, the present invention relates to a method for producing a composite semipermeable membrane, comprising a step in which an amine solution containing a polyfunctional amine component and an organic solution containing a polyfunctional acid halide component are brought into contact on a porous support to form a skin layer containing a polyamide resin on the surface of the porous support, wherein the polyfunctional amine component contains N,N′ -dimethyl-meta-phenylenediamine and the solvent of the organic solution is an organic solvent having a boiling point of 130 to 250° C.

The method for producing a composite semipermeable membrane of the present invention is characterized by using N,N′ -dimethyl-meta-phenylenediamine as a polyfunctional amine component and an organic solvent with a boiling point of 130 to 250° C. as a solvent for an organic solution containing a polyfunctional acid halide component. It is not clear why a composite semipermeable membrane that has excellent oxidation resistance is obtained by using these components, but the reason may be considered as follows. It is thought that a polyamide resin having excellent oxidation resistance is provided by using N,N′ -dimethyl-meta-phenylenediamine as a polyfunctional amine component. In addition, since the organic solvent having a boiling point of 130 to 250° C. has a slow evaporation speed, the reaction time of the N,N′ -dimethyl-meta-phenylenediamine with the polyfunctional acid halide component becomes longer so that the polyamide resin is produced in an increased amount, and it is believed that a dense skin layer where the polyamide resin gets entangled is formed at the same time. Therefore, the polyamide resin is hardly deteriorated by an oxidizing agent, and even if the polyamide resin is slightly deteriorated, it is also considered that excellent oxidation resistance is developed due to the presence of the non-deteriorated polyamide resin in the dense, entangled state.

If the boiling point of the organic solvent is less than 130° C., a skin layer excellent in oxidation resistance is not formed. On the other hand, if the boiling point of the organic solvent exceeds 250° C., such an organic solvent is practically unsuitable because a great deal of heat energy is required to evaporate the solvent.

The organic solvent is preferably an isoparaffinic solvent or a naphthenic solvent. By using these solvents, it is possible to further improve the oxidation resistance of the composite semipermeable membrane.

### Effect of the Invention

Since the composite semipermeable membrane of the present invention has superior oxidant resistance, the composite semipermeable membrane can also be used when employing a treatment method for sterilizing microorganisms in water with an oxidizing agent. Conventionally, pretreatment by using an ultrafiltration membrane or a microfiltration membrane has been performed so as to remove microorganisms in water. However, use of the composite semipermeable membrane of the present invention makes it possible to omit such a pretreatment or simplify the pretreatment. Therefore, the water treatment method using the composite semipermeable membrane of the present invention is more advantageous compared to the conventional water treatment method from the viewpoint of cost and ecological footprint.

### Mode for Carrying Out the Invention

Hereinafter, the embodiments of the present invention will be described. The method for producing the composite semipermeable membrane of the present invention, comprising a step in which an amine solution containing a polyfunctional amine component and an organic solution containing a polyfunctional acid halide component are brought into contact on a porous support to form a skin layer containing a polyamide resin on the surface of the porous support.

In the present invention, N,N′ -dimethyl-meta-phenylenediamine as a polyfunctional amine component is used. It is preferred to use only N,N′-dimethyl-meta-phenylenediamine as the polyfunctional amine component, but the following aromatic, aliphatic, or alicyclic polyfunctional amines may be used in combination with the N,N′-dimethyl-meta-phenylenediamine within a range not to impair the effects of the present invention.

The aromatic polyfunctional amines include, for example, m-phenylenediamine, p-phenylenediamine, o-phenylenediamine, 1,3,5-triamino benzene, 1,2,4-triamino benzene, 3,5-diaminobenzoic acid, 2,4-diaminotoluene, 2,6-diaminotoluene, 2,4-diaminoanisole, amidol, xylylene diamine etc. These polyfunctional amines may be used independently, and two or more kinds may be used in combination.

The aliphatic polyfunctional amines include, for example, ethylenediamine, propylenediamine, tris(2-aminoethyl)amine, N-phenyl-ethylenediamine, etc. These polyfunctional amines may be used independently, and two or more kinds may be used in combination.

The alicyclic polyfunctional amines include, for example, 1,3-diaminocyclohexane, 1,2-diaminocyclohexane, 1,4-diaminocyclohexane, piperazine, 2,5-dimethylpiperazine, 4-aminomethylpiperazine, etc. These polyfunctional amines may be used independently, and two or more kinds may be used in combination.

In the case where N,N′-dimethyl-meta-phenylenediamine and the polyfunctional amine are used in combination, it is preferable to use N,N′-dimethyl-meta-phenylenediamine in an amount of 85% by weight or more, more preferably 95% by weight or more, relative to the total amount of the polyfunctional amine components.

The polyfunctional acid halide component represents polyfunctional acid halides having two or more reactive carbonyl groups.

The polyfunctional acid halides include aromatic, aliphatic, and alicyclic polyfunctional acid halides.

The aromatic polyfunctional acid halides include, for example trimesic acid trichloride, terephthalic acid dichloride, isophthalic acid dichloride, biphenyl dicarboxylic acid dichloride, naphthalene dicarboxylic acid dichloride, benzenetrisulfonic acid trichloride, benzenedisulfonic acid dichloride, chlorosulfonyl benzenedicarboxylic acid dichloride etc.

The aliphatic polyfunctional acid halides include, for example, propanedicarboxylic acid dichloride, butane dicarboxylic acid dichloride, pentanedicarboxylic acid dichloride, propane tricarboxylic acid trichloride, butane tricarboxylic acid trichloride, pentane tricarboxylic acid trichloride, glutaryl halide, adipoyl halide etc.

The alicyclic polyfunctional acid halides include, for example, cyclopropane tricarboxylic acid trichloride, cyclobutanetetracarboxylic acid tetrachloride, cyclopentane tricarboxylic acid trichloride, cyclopentanetetracarboxylic acid tetrachloride, cyclohexanetricarboxylic acid trichloride, tetrahydrofurantetracarboxylic acid tetrachloride, cyclopentanedicarboxylic acid dichloride, cyclobutanedicarboxylic acid dichloride, cyclohexanedicarboxylic acid dichloride, tetrahydrofuran dicarboxylic acid dichloride, etc.

These polyfunctional acid halides may be used independently, and two or more kinds may be used in combination. In order to obtain a skin layer having higher salt-blocking property, it is preferred to use aromatic polyfunctional acid halides. In addition, it is preferred to form a cross linked structure using polyfunctional acid halides having trivalency or more as at least a part of the polyfunctional acid halide components.

Furthermore, in order to improve performance of the skin layer including the polyamide resin, polymers such as polyvinyl alcohol, polyvinylpyrrolidone, and polyacrylic acids etc., and polyhydric alcohols, such as sorbitol and glycerin, may be copolymerized.

The porous support for supporting the skin layer is not especially limited as long as it has a function for supporting the skin layer. Materials for formation of the porous support include various materials, for example, polyarylether sulfones, such as polysulfones and polyether sulfones; polyimides; polyvinylidene fluorides; etc., and polysulfones and polyarylether sulfones are especially preferably used from a viewpoint of chemical, mechanical, and thermal stability. The thickness of this porous support is usually approximately 25 to 125 μm, and preferably approximately 40 to 75 μm, but the thickness is not necessarily limited to them. The porous support may be reinforced with backing by cloths, nonwoven fabric, etc.

The porous support may have a symmetrical structure or an asymmetrical structure. However, the asymmetrical structure is preferred from the viewpoint of satisfying both of supporting function and liquid permeability of the skin layer. The average pore diameter of the skin layer formed side of the porous support is preferably from 0.01 to 0.5 μm.

Further, an epoxy resin porous sheet may be used as the porous support. The average pore diameter of the epoxy resin porous sheet is preferably from 0.01 to 0.4 μm.

Processes for forming the skin layer including the polyamide resin on the surface of the porous support is not in particular limited, and any publicly known methods maybe used. For example, the publicly known methods include an interfacial condensation method, a phase separation method, a thin film application method, etc. The interfacial condensation method is a method, wherein an amine aqueous solution containing a polyfunctional amine component, an organic solution containing a polyfunctional acid halide component are forced to contact together to form a skin layer by an interfacial polymerization, and then the obtained skin layer is laid on a porous support, and a method wherein a skin layer of a polyamide resin is directly formed on a porous support by the above-described interfacial polymerization on a porous support. Details, such as conditions of the interfacial condensation method, are described in Japanese Patent Application Laid-Open No. S58-24303, Japanese Patent Application Laid-Open No. H01-180208, and these known methods are suitably employable.

In the present invention, it is preferred to form a skin layer by an interfacial polymerization method including forming a coating layer of an amine solution containing N,N′-dimethyl-meta-phenylenediamine on a porous support and bringing an organic solution containing a polyfunctional acid halide component into contact with the coating layer of the amine solution.

As the solvent for the amine solution, there are exemplified alcohols such as ethylene glycol, isopropyl alcohol, and ethanol, and a mixed solvent of these alcohols with water. In particular, it is preferable to use ethylene glycol as the solvent for the amine solution.

In the interfacial polymerization method, although the concentration of the polyfunctional amine component in the amine solution is not in particular limited, the concentration is preferably 0.1 to 5% by weight, and more preferably 0.5 to 2% by weight. Less than 0.1% by weight of the concentration of the polyfunctional amine component may easily cause defect such as pinhole. In the skin layer, leading to tendency of deterioration of salt-blocking property. On the other hand, the concentration of the polyfunctional amine component exceeding 5% by weight allows easy permeation of the polyfunctional amine component into the porous support to be an excessively large thickness and to raise the permeation resistance, likely giving deterioration of the permeation flux.

Although the concentration of the polyfunctional acid halide component in the organic solution is not in particular limited, it is preferably 0.01 to 5% by weight, and more preferably 0.05 to 3% by weight. Less than 0.01% by weight of the concentration of the polyfunctional acid halide component is apt to make the unreacted polyfunctional amine component remain, to cause defect such as pinhole in the skin layer, leading to tendency of deterioration of salt-blocking property. On the other hand, the concentration exceeding 5% by weight of the polyfunctional acid halide component is apt to make the unreacted polyfunctional acid halide component remain, to be an excessively large thickness and to raise the permeation resistance, likely giving deterioration of the permeation flux.

As the solvent used for the organic solution, there is exemplified an organic solvent having a boiling point of 130 to 250° C. It is preferable to use an organic solvent having a boiling point of 145 to 250° C.; it is more preferable to use an organic solvent having a boiling point of 160 to 250° C.; it is even more preferable to use an organic solvent having a boiling point of 180 to 250° C., in view of improving the oxidant resistance of the composite semipermeable membrane.

The organic solvent includes, for example, hydrocarbon solvents, and may be used alone or may be used as a mixture thereof. In the case of a mixture, the average value of the distillation temperature range is defined as the boiling point. Examples of such an organic solvent include, for example, saturated hydrocarbons such as nonane, decane, undecane, dodecane, and tridecane; isoparaffin-based solvents such as IP Solvent 1620, IP Clean LX, and IP Solvent 2028; and naphthene-based solvents such as Exxsol D30, Exxsol D40, Exxsol D60, Exxsol D80, Naphtesol 160, Naphtesol 200, and Naphtesol 220. Of these, the isoparaffin-based solvents or the naphthene-based solvents are preferable, and from the viewpoint of improving the chlorine resistance, the naphthene-based solvents are particularly preferred.

Various kinds of additives may be added to the amine solution or the organic solution in order to provide easy film production and to improve performance of the composite semipermeable membrane to be obtained. The additives include, for example, surfactants, such as sodium dodecylbenzenesulfonate, sodium dodecyl sulfate, and sodium lauryl sulfate; basic compounds, such as sodium hydroxide, trisodium phosphate, triethylamine, etc. for removing hydrogen halides formed by polymerization; acylation catalysts; compounds having a solubility parameter of 8 to 14 (cal/cm³)^{1/2} described in Japanese Patent Application Laid-Open No. H08-224452.

The period of time after application of the amine solution until application of the organic solution on the porous support depends on the composition and viscosity of the amine solution, and on the pore size of the surface layer of the porous support, and it is preferably 15 seconds or less, and more preferably 5 seconds or less. Application interval of the solution exceeding 15 seconds may allow permeation and diffusion of the amine solution to a deeper portion in the porous support, and possibly cause a large amount of the residual unreacted polyfunctional amine components in the porous support. In this case, removal of the unreacted polyfunctional amine component that has permeated to the deeper portion in the porous support is probably difficult even with a subsequent membrane washing treatment. Excessive amine solution may be removed after covering by the amine solution on the porous support.

In the present invention, after the contact with the coating layer of amine solution and the organic solution, it is preferred to remove the excessive organic solution on the porous support, and to dry the formed membrane on the porous support by heating at a temperature of 70° C. or more, forming the skin layer. Heat-treatment of the formed membrane can improve the mechanical strength, heat-resisting property, etc. The heating temperature is more preferably 70 to 200° C., and especially preferably 100 to 150° C. The heating period of time is preferably approximately 30 seconds to 10 minutes, and more preferably approximately 40 seconds to 7 minutes.

The thickness of the skin layer formed on the porous support is not in particular limited, and it is usually approximately 0.01 to 100 μm, and preferably 0.1 to 10 μm.

There is no limitation on the shape of the composite semipermeable membrane of the present invention. That is, the composite semipermeable membrane can take any conceivable membrane shapes, such as a flat membrane or a spiral element. Further, conventionally known various treatments maybe applied to the composite semipermeable membrane so as to improve its salt-blocking property, water permeability, and oxidation resistance.

Further, in the present invention, the composite semipermeable membrane may be of a dry type from the viewpoint of excellent processability and storage stability. In the drying treatment, there is no limitation on the shape of the composite semipermeable membrane. In other words, it is possible to apply the drying treatment to any conceivable membrane shapes including a flat membrane, a spiral membrane, and the like. For example, a composite semipermeable membrane maybe processed into a spiral shape to prepare a membrane unit and then the membrane unit may be dried to prepare a dry spiral element.

### EXAMPLE

The present invention will, hereinafter, be described with reference to Examples, but the present invention is not limited at all by these Examples.

### Evaluation and Measuring Method

### Measurement of Permeation Flux and Salt-Blocking Rate

The prepared flat shape composite semipermeable membrane was cut into a predetermined shape and size, and was set to a cell for flat shape evaluation. An aqueous solution containing 0.15% NaCl and being adjusted to pH 7 with NaOH was allowed to contact to a supply side and permeation side of the membrane at a differential pressure of 1.5 Mpa at 25° C. A permeation velocity and electric conductivity of the permeated water obtained by this operation were measured, and a permeation flux (m³/m²·d) and a salt-blocking rate (%) were calculated. The correlation (calibration curve) of the NaCl concentration and electric conductivity of the aqueous solution was made beforehand, and the salt-blocking rate was calculated by the following equation. Further, the composite semipermeable membrane was dipped in an aqueous solution containing 500 ppm of calcium chloride (free chlorine concentration: 200 ppm) at 40° C. for 7 days. After that, the composite semipermeable membrane was taken out from the aqueous solution, and its permeation flux and salt-blocking rate were measured in the same manner as above. In addition, the change degree of the permeation flux was calculated by the following equation. The smaller the change degree of the permeation flux is, the more excellent the oxidation resistance is.

Salt-blocking rate (%)={1-(NaCl concentration in permeated liquid [mg/L])/(NaCl concentration in supply solution) [mg/L]}×100

Change degree of permeation flux=(Permeation flux after dipping in aqueous calcium chloride solution [m³/m²·d])/(Initial permeation flux [m³/m²·d])

### Example 1

N,N′-Dimethyl-meta-phenylenediamine (3% by weight), sodium lauryl sulfate (0.15% by weight), triethylamine (2.5% by weight), and camphorsulfonic acid (5% by weight) were dissolved in ethylene glycol to prepare an amine solution. In addition, trimesic acid chloride (0.2% by weight) and isophthalic acid chloride (0.4% by weight) were dissolved in Exxsol D30 (manufactured by Exxon Mobil Corporation, distillation range 130 to 160° C., boiling point 148° C.) to prepare an acid chloride solution. Then, the amine solution was applied onto a porous support and the excess amine solution was subsequently removed to form an amine solution coating layer. After that, the acid chloride solution was applied onto the surface of the amine solution coating layer. Then, after removal of the excess solution, the coating layer was held in a hot air dryer of 100° C. for 5 minutes to form a skin layer containing a polyamide-based resin on the porous support, thereby to prepare a composite semipermeable membrane.

### Example 2

A composite semipermeable membrane was prepared in the same manner as in Example 1, except for using Naphtesol 160 (manufactured by JX Nippon Oil & Energy Co., Ltd., distillation range: 157 to 179° C., boiling point: 168° C.) instead of Exxsol D30 in Example 1.

### Example 3

A composite semipermeable membrane was prepared in the same manner as in Example 1, except for using Exxsol D40 (manufactured by Exxon Mobil Corporation, distillation range 147 to 199° C., boiling point 173° C)instead of Exxsol D30 in Example 1.

### Example 4

A composite semipermeable membrane was prepared in the same manner as in Example 1, except for using Naphtesol 200 (manufactured by JX Nippon Oil & Energy Co., Ltd., distillation range: 201 to 217° C., boiling point: 209° C.) instead of Exxsol D30 in Example 1.

### Example 5

A composite semipermeable membrane was prepared in the same manner as in Example 1, except for using Exxsol D80 (manufactured by Exxon Mobil Corporation, distillation range 200 to 250° C., boiling point 225° C)instead of Exxsol D30 in Example 1.

### Comparative Example 1

A composite semipermeable membrane was prepared in the same manner as in Example 1, except for using IP Solvent 1016 (manufactured by Idemitsu Kosan Co., Ltd., distillation range 73 to 140° C., boiling point 107° C.) instead of Exxsol D30 in Example 1.

### Comparative Example 2

A composite semipermeable membrane was prepared in the same manner as in Example 1, except for using Exxsol DSP100/140 (manufactured by Exxon Mobil Corporation, distillation range 98 to 140° C., boiling point 119° C.) instead of Exxsol D30 in Example 1.

### Comparative Example 3

A composite semipermeable membrane was prepared in the same manner as in Example 1, except for using meta-phenylenediamine instead of N,N′ -dimethyl-meta-phenylenediamine in Example 1.

TABLE 1

| | | | | Salt-blocking | | Permeation flux | | Change |
|---|---|---|---|---|---|---|---|---|
| | | | | rate (%) | | (m³/m² · d) | | degree of |
| | | | Boiling | Before | After | Before | After | permeation |
| | Diamine | Organic solvent | point (° C.) | dipping | dipping | dipping | dipping | flux |
| Example 1 | N,N-dimethyl-meta-phenylenediamine | Exxsol D30 | 148 | 97.6 | 93.7 | 0.48 | 0.56 | 1.2 |
| Example 2 | N,N-dimethyl-meta-phenylenediamine | Naphthesol 160 | 168 | 97.5 | 89.0 | 0.44 | 0.36 | 0.8 |
| Example 3 | N,N-dimethyl-meta-phenylenediamine | Exxsol D40 | 173 | 97.6 | 89.4 | 0.37 | 0.34 | 0.9 |
| Example 4 | N,N-dimethyl-meta-phenylenediamine | Naphthesol 200 | 209 | 96.9 | 91.2 | 0.38 | 0.41 | 1.1 |
| Example 5 | N,N-dimethyl-meta-phenylenediamine | Exxsol D80 | 225 | 95.3 | 85.8 | 0.49 | 0.44 | 0.9 |
| Comparative | N,N-dimethyl-meta-phenylenediamine | IP Solvent 1016 | 107 | 95.3 | 82.0 | 0.36 | 1.12 | 3.1 |
| Example 1 | | | | | | | | |
| Comparative | N,N-dimethyl-meta-phenylenediamine | Exxsol DSP 100/140 | 119 | 96.4 | 88.3 | 0.36 | 0.83 | 2.3 |
| Example 2 | | | | | | | | |
| Comparative | Meta-phenylenediamine | Exxsol D30 | 148 | 99.7 | 67.8 | 0.59 | 8.47 | 14.4 |
| Example 3 | | | | | | | | |

It can be seen from Table 1 that the composite semipermeable membranes prepared in Examples 1 to 5 by using N,N′ -dimethyl-meta-phenylenediamine as a polyfunctional amine component and an organic solvent having a boiling point of 130 to 250° C. as a solvent of the organic solution, have a small change degree of permeation flux between before and after dipping in an aqueous oxidant solution and have excellent oxidation resistance.

### INDUSTRIAL APPLICABILITY

The composite semipermeable membrane of the present invention is suitably used for production of ultrapure water, desalination of brackish water or sea water, etc., and usable for removing or collecting pollution sources or effective substances from pollution, which causes environment pollution occurrence, such as dyeing drainage and electrodeposition paint drainage, leading to contribute to closed system for drainage. Furthermore, the membrane can be used for concentration of active ingredients in foodstuffs usage, for an advanced water treatment, such as removal of harmful component in water purification and sewage usage etc. Moreover, the membrane can be used for waste water treatment in oil fields or shale gas fields.

1. A method for producing a composite semipermeable membrane, comprising a step in which an amine solution containing a polyfunctional amine component and an organic solution containing a polyfunctional acid halide component are brought into contact on a porous support to form a skin layer containing a polyamide resin on the surface of the porous support, wherein
the polyfunctional amine component contains N,N′-dimethyl-meta-phenylenediamine and
the solvent of the organic solution is an organic solvent having a boiling point of 130 to 250° C.

2. The method for producing a composite semipermeable membrane according to claim 1, wherein the organic solvent is an isoparaffinic solvent or a naphthenic solvent.

3. A composite semipermeable membrane obtained by the production method according to claim 1.

4. A composite semipermeable membrane obtained by the production method according to claim 2.
